(19) United States
(12) Patent Application Publication
(10) Pub. No.: US 2006/0221620 A1
(43) Pub. Date: Oct. 5, 2006

(54) Replacement module for recessed light

(76) Inventor: Philip Thomas, New York, NY (US)

Correspondence Address: Jonathan B. Schafrann, 2034 Quaker Ridge Road, Croton-On-Hudson, NY, 10520, US

(21) Appl. No.: 11/095,224

(22) Filed: Mar. 31, 2005

(51) Int. Cl. F21S 8/00

(52) U.S. Cl. 362/364; 362/260; 362/147; 362/148; 362/399

(57) ABSTRACT

The present invention provides a replacement module for a recessed light fixture, said module having at least a strut and attachment means. The flexible struts that retain the replacement module within a high-hat housing are either mechanical or magnetic, and if magnetic are fashioned from neodymium and depend outwardly either in an upward or downward direction.

### FIELD OF THE INVENTION

The present invention relates to recessed lighting and more particularly to a module for replacing a recessed light.

### BACKGROUND OF THE INVENTION

Whether it is a weekend handyman or sophisticated general contractor, lighting fixtures represent a time consuming and difficult undertaking. To replace a light fixture not only requires great care in removal, but also in insuring proper replacement dimension, fit and re-wiring. One strategy is to utilize “standard-sized ” fixtures and suffer through the whole replacement process. Another method is to utilize a replacement module that basically screws into a standard Edison type bulb base and utilize a kit including trim. The major problem with replacement modules of any type is that they require exact placement and an identity of size so that locking or interlocking may be achieved. Another problem is based on once the fixture replacement is installed, it cannot then be changed easily without changing the whole fixture. The installer must contend with two phenomena: the first being a steady and elevated temperature derived from the bulb heat, and the second being the weight of the replacement module pulling the replacement module down and out of the fixture seat. As a result the replacement module has historically been anchored to a seating arrangement at or near the connection of the wiring to the power source and original installation structure.

### PRIOR ART

There is a recognized need for a replacement module for recessed or high hat lamp fixtures. Often the impetus for changing the fixture is to change from incandescent or halogen lighting to a less expensive variety like a fluorescent bulb which utilizes a gas filled chamber that lights on exposure to current.

U.S. Pat. No. 3,660,651 issued to Miles, Jr. discloses a recessed ajustable light with a high hat can and a multiple armed scissoring assembly to adjust the inner light up or down.

U.S. Pat. No. 4,232,361 issued to Kelsall discloses another adjustable light within a recessed lighting fixture or high hat, using a series of tracks and rollers to adjust the light within.

U.S. Pat. No. 5,580,158 issued to Aubrey et al discloses a retrofit lighting fixture to change an incandescent recessed light to a fluorescent light by screw mounting a retrofit module with wiring and ballast therein.

There are many references to recessed and track lighting that obtain to methods for suspending a light within a “high hat” housing. Without regard to the methodology, there is not one reference that implies the use of a strut system as disclosed herein.

### OBJECTS OF THE INVENTION

It is the principal object of the instant invention to provide the user with a replacement module for high hat type recessed light fixtures.

It is another object of the instant invention to provide a replacement module that easily retrofits existing fixtures without modification.

It is yet another object of the instant invention to provide a replacement module for a light fixture that is easily withdrawn from the fixture.

### SUMMARY OF THE INVENTION

The instant invention appertains to a replacement module for recessed lighting fixtures. The module retrofits with a screw type base and includes a reflector and reflector cone integrating with a lower portion on one end and a seating area on the opposite end. On the outer wall of the lower portion of the reflector there is at least a single outstanding strut, the strut being flexible. The replacement module may be constructed to employ at least one or a series of flexible struts, each strut affixed to the lower portion of the reflector on one end and terminating in a rare earth magnet being affixed to the strut. As an alternate embodiment a series of one-way teeth may be operatively substituted for the magnet on the strut or struts. Other mechanical attachment means may be operatively substituted and may be independently affixed or affixed over a pre-existing attachment means. The struts may be spatially laid out around the outer circumference of the replacement module to hold the inserted module within an existing fixture like the well known high hat.

For non-magnetic fixtures (plastics of one sort or another —or Aluminum) —the at least two fingers may include a set of one-way teeth thereon so that compression of the fingers creates contact between the one-way teeth and the sidewall of the fixture.

### BRIEF DESCRIPTION OF THE DRAWINGS

It should be understood, by one skilled in the art, that the drawings depict certain embodiments of the invention and therefore are not to be considered a limitation in the scope of the instant invention, but that these and other advantages of the present invention will be more fully understood by reference to the following detailed description when read in conjunction with the attached drawings in which:

FIG. 1 is a side view of the replacement module;

FIG. 2 is a bottom plan view, taken along lines 2-2 of FIG. 1 thereof;

FIG. 3 is a side view of the replacement module within a housing, with struts in an extended and reversibly attached condition;

FIG. 4 is a side view thereof, wherein the struts have a toothed attachment means;

FIG. 5 is a bottom plan view, taken along lines 5-5 of FIG. 4 thereof; and

FIG. 6 is a side view of the replacement module within a housing, with struts in an extended and reversibly attached condition.

### DETAILED DESCRIPTION OF THE PREFERRED EMBODIMENT

To wit, turning now with more specificity to the drawings, wherein like numerals refer to like parts throughout, the numeral 100 appertains generally to a replacement module for a recessed light fixture. It should be noted that generally the preferred embodiment for the attachment means is a magnet formed from a rare earth material. The choice of rare earth magnets is neodymium or other newer ferrous or non-ferrous magnets or magnets in accordance with other magnetic processes. Other magnetic systems like traditional ferrite magnets lose their magnetism over time and prolonged periods of super-ambient temperature extremes. Light fixtures generate a heightened amount of heat from incandescent and halogen bulbs and therefore, a ferrite system would fail. Moreover, rare earth magnets have been used for a variety of industrial uses and as their cost has declined so that they have become cost effective for most purposes. Further it is understood that the preferred type of lighting fixture is a recessed type light fixture also known as a high hat fixture.

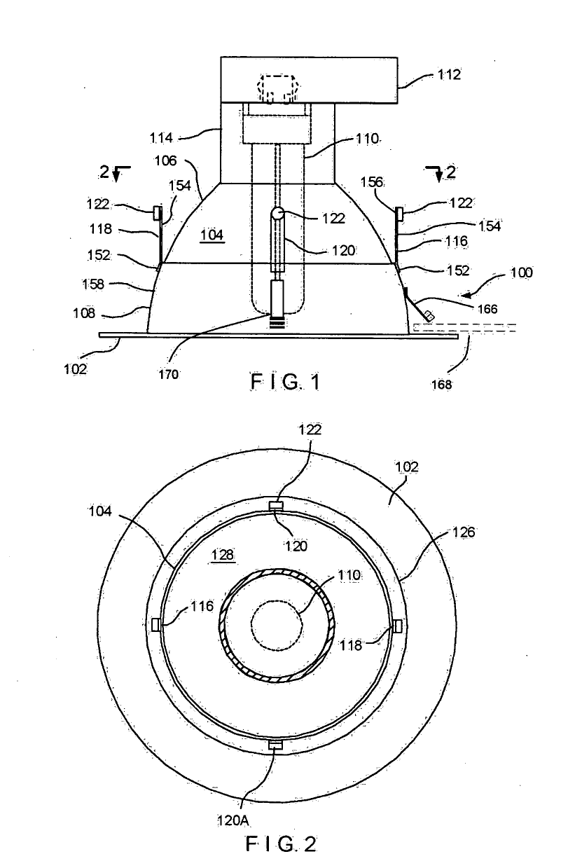

Turning to FIGS. 1 and 2, which show the replacement module 100 with a trim ring 102 and reflector generally set out as 104, said reflector 104 being divided into a reflector cone 106, a lower portion of the reflector 108 and an upper portion 114. It should be noted that the ballast and/or wiring is depicted by the numeral 112, but the ballast and wiring is neither described nor claimed and may be any one of several prior art or public adaptations. Light 110 is set out in dotted lines and may be either fluorescent, incandescent, halogen, light emitting diode or any other type of bulb. Although not enumerated herein, it is inherent hereto that a power source such as a hardwire system supplying house current is intended to deliver power to the replacement module.

With reference to the same FIGS. 1 and 2, struts 116,118 and 120 are set out as possessing a strut body 154, a foot 152, an upper area 156 opposite foot 152 in communication with an attachment means 122. Foot 152 may be angled so the attachment disposes strut 116, 118 and 120 upwards at about a 90 degree angle relative to the trim ring 102 below. Attachment means 122 is preferably a rare earth neodymium magnet. It is most preferred that struts 116-120A be spring-like in overall attitude, and as a spring may be flat, round, circular or a combination thereof.

Illustrated by FIGS. 1-6, struts 116, 118 and 120 are most preferably spring-like or flexible and are from about 1 inch to about 12 inches in length of from about 0.25 inches to about 3 inches in width and from about 0.01 mm to about 0.1 mm in thickness. The aforementioned struts 116-120, which are flexible are preferred to be of springy non-magnetic material, although a magnetizable material can be operatively substituted without distinction. A springy base metal may be preferred for said struts 116-120. Therefore, struts 116-120 may be constructed from a metal which is either magnetic or non-magnetic or a polymer. As a most preferred embodiment the foot 152 forms an angled flange so that it may be affixed at attachment site 124 to outer wall 158 of lower portion of reflector 108. Given angled foot 152 attachment to outer wall 158 of reflector 108 may be achieved by any number of means. For example attachment of foot 152 to attachment site 124 of outer wall 158 may be achieved by heat welding, gluing, forming, sonic welding, threaded or non-threaded fasteners or other accepted industrial method.

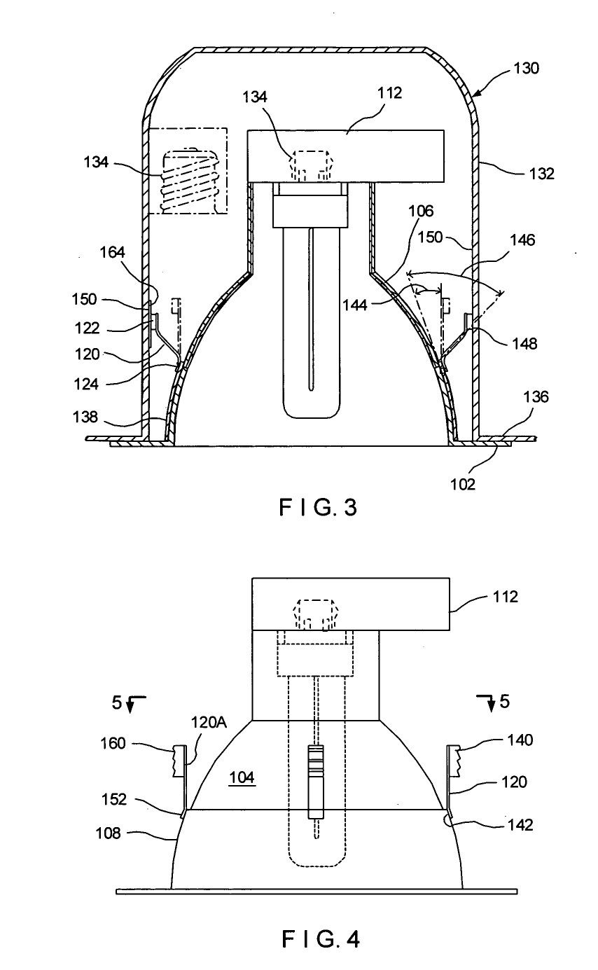

As presented in FIG. 3, a mounting band 138, may be disposed around reflector 104, or more appropriately around reflector cone 106 or the lower portion 108 to provide a purchase for strut 116-120A, for replacement modules fashioned from thermoplastic polymers. It should be noted that a metallic insert or band 164 may be mounted on inner wall 150 of housing 130. By placing insert or band 164, and by constructing said insert or band from a magnetizeable material like a base metal, one can utilize the magnetic attachment means with a houring 130 that is constructed from a non-magnetizeable material —like a thermoplastic polymer. While it is preferred to have more than one strut 116, a bayonet or band type mount and larger attachment means (magnet) 122 may be operatively substituted. As illustrated by the FIGS. 1, 2, 4, and 5 at least two struts 116 and 118 are most preferred. For example if the circumference is 360 degrees it is preferred to have at least one strut 116 affixed with an attachment means 122 (magnet) at 0 degrees and 180 degrees around the circumference, with a third strut 120 placing all others equidistant. For three struts the spacing would be every 120 degrees (0°, 120° and 240°) and for 4 struts every 90 degrees and so on with regard to the number of struts and their placement. The extension of strut(s) (116-120A) signifies deployment, which reversibly attaches the attachment means 122 or 160-162 to the inner wall 138 of housing or can 130.

FIG. 2 best illustrates reflector 104 and trim ring 102, with struts 116, 118, 120, and 120A in an upstanding and non-deployed condition. The edge of trim ring 126 provides a seamless overlap over a fixture aperture when replacement module 100 is fitted within a fixture aperture. One can clearly see that the attachment means (magnet) 122 is in an upstanding and non-deployed condition.

FIG. 4 when taken in view of FIGS. 1 and 2, the disclosure incorporated by reference, shows an alternate attachment means 140 which communicates with strut 120, and which is adhered to the distal end thereof. When reflector 104 is received into a non-magnetic housing through a central opening or aperture, like a plastic high hat fixture can, one must utilize a different type of attachment means. Referring to FIG. 4, an alternate embodiment would be to employ an attachment means 140 with interlocking teeth 160. It is understood that a variety of mechanical attachment means may be operatively substituted without sacrificing retention of replacement module 100. Affixing attachment means 140 may be achieved by any number of methods including gluing, welding, thermo-forming, mechanical fasteners or the snapping an attachment means 140 over the upper part of strut body 156. Strut 120 A terminates in angled foot 152, said foot being affixed through attachment site to lower portion 108 of reflector 104 at attachment site 142. It should be noted that the actual attachment may differ according to the material employed, with non-metallic reflectors requiring gluing, sonic welding, or heat fusion, while metallic reflectors require solder, welds, mechanical fasteners of one sort or another, or special purpose glues. Another method for adhering strut 120 to reflector 104 is thermo forming or casting with struts already in place.

FIGS. 3 and 6 depict replacement module 100 within a housing 130, the housing being the can of a high hat light fixture. Wiring 112 may also be the ballast of a fluorescent light while 134 is an Edison base type screw in connection, the wiring being neither described nor claimed herein. FIG. 3 specifically shows the travel arc of strut 120, as attachment means 122, as a magnet, is reversibly affixed to interior wall 148 of housing 130. In dotted lines strut 120 is in an upstanding conformation while the solid lined strut 120 being in the deployed condition and in operative or magnetic communication with the interior wall, the wall being magnetizable. Attachment means 122 as stated herein is preferably fashioned from a neodymium magnet, so that when used in the disclosure attachment means 122 preferably is meant to depict a neodymium or rare earth magnet.

With reference herein to FIG. 3 and to FIG. 6 the upstanding strut 120 in the non-deployed condition is from about 5 degrees to about 90 degrees, while the deployed angle 146 is from about 5 degrees to about 90 degrees. The attachment means 122 or 160-162 determines the angle by whether there is a corresponding series of attachment means 160-162. Notwithstanding the foregoing, strut 120, as mentioned hereinabove, should preferably be spring like so that attachment is further supported by the inherent spring action of strut 120. One advantage of the use of a neodymium magnet as the attachment means 122 in conjunction with strut 120 is that placement within housing 130 is not critical. In fact, placement within housing 130 (if the can is of a magnetizeable metal) can be made anywhere within a wide band, thus providing for ease of installation. As a result reversible retention of replacement module 100 within housing 132 is successfully attained.

Referring to FIGS. 1 and 6, an alternate embodiment of strut 116-120A may be viewed as struts 166, 166A and 170. FIG. 1 clearly shows downwardly depending struts 166, and 170 said struts being in a reversed conformation and as stated hereinbefore downwardly depending. With note to ceiling tile 168 set out in dotted lines, downwardly depending strut 166 can be alternately utilized to retain replacement module 100 within housing 130 of FIG. 6 by retaining said module replacement 100 by contacting ceiling tile 168 with downwardly depending strut 166, 166A, 170, and holding replacement module 100 within a space in the ceiling. FIG. 6 best illustrates downwardly depending struts 166 and 166A in communication with housing 132 and magnetically and reversibly retaining replacement module therein. As other embodiments, struts 166-170 may be fashioned as described herein for struts 116-120 and possess attachment means in accordance therewith.

From FIGS. 3 and 6 one can see trim ring 102 abuts the lower margin of housing or can 136 of housing 130, while the exterior wall 132 would be in communication with the surrounding ceiling and frame of a house or other structure. Illustrated therein, the retention of replacement module is dependent on strut 120 (includes 116-120A) and attachment means 122 (a neodymium magnet) or 160-162 interlocking teeth.

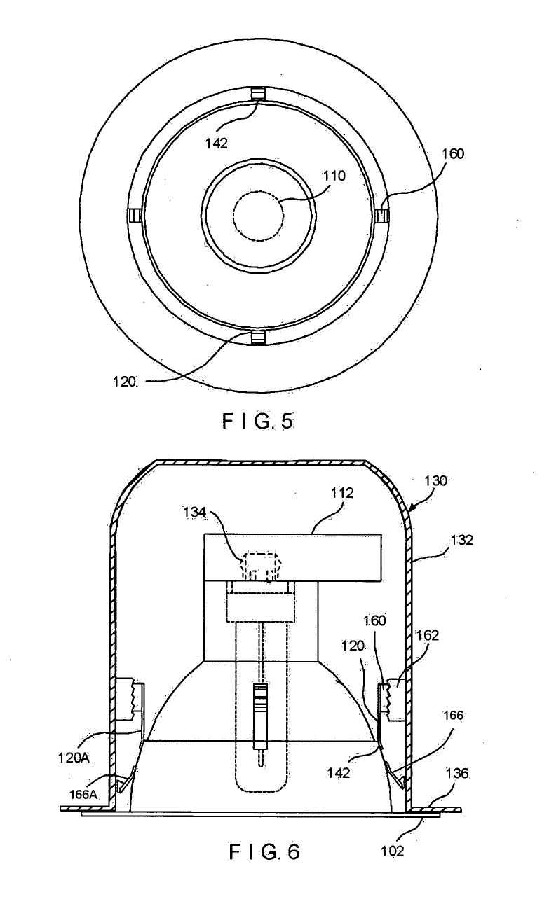

Turning to FIG. 5, attachment means 160 may be viewed in relation to light source 110 as strut 120 depends outward and upward from attachment site 142 of reflector 104. As an alternate embodiment and in accordance with FIG. 6, strut 166 depends outwardly and downwardly from reflector 104. As a general rule, an outwardly depending strut as 120 or 166 is most preferred. While certain angles have been described herein it is understood that the outward depending strut condition may be achieved by use of an outwardly curving conformation of struts 116-120, and 166-170 (not illustrated). As stated herein, struts 116-120 and 166-170 depend outwardly and either upwardly or downward direction relative to reflector 104.

While the foregoing embodiments of the invention have been set forth in considerable detail for the purposes of making a complete disclosure of the invention, it will be apparent to those of skill in the art that numerous changes may be made in such details without departing from the spirit and the principles of the invention.

I claim:

1. A replacement module for a recessed light fixture comprising:
a reflector adapted to retain a light source in communication with;
a wiring means, said wiring means in operative communication with a power source adapted to transfer current to said light source; and
at least one strut in communication with said reflector, said strut being flexible and terminating in an attachment means on one end and foot on the other, depending outward so that communication with a housing achieves reversible retention to said housing and retains said replacement module therein.

2. An attachment means as described in claim 1 further comprising a rare earth magnet, a newer ferrous or non-ferrous magnet, or magnet by other magnetizing process, a mechanical attachment means or a combination thereof.

3. A rare earth magnet as described in claim 2, further comprised of neodymium.

4. A mechanical attachment means described in claim 2 further comprised of one way teeth and a corresponding receiving means of interlocking teeth.

5. A strut as described in claim 1 further comprising a magnetizeable material.

6. A magnetizeable material as described in claim 5 wherein said metal is a base metal composed of iron.

7. A strut as described in claim 1 further comprising a non-magnetizeable material.

8. A non-magentizeable material as described in claim 7 further comprising a thermoplastic polymer material or a non-magnetic metal.

9. A strut as described in claim 1 depending upward and outward at an angle of from about 5 degrees to about 90 degrees.

10. A strut as described in claim 1 that is from about 1 inch to about 12 inches long, and from about 0.25 inches to about 3 inches wide and from about 0.01 millimeters to about 0.1 millimeters thick.

11. A strut as described in claim 1 wherein said foot is further comprised of an angled end in communication with the outer surface of the reflector.

12. A strut as described in claim 1 that is spring like.

13. A strut that is spring like in accordance with claim 10 wherein said spring-like strut is flat, round, circular or combinations thereof.

14. A strut as described in claim 1 wherein said strut is disposed in an upward direction relative to said reflector.

15. A strut as described in claim 1 wherein said strut is disposed in a downward direction relative to said reflector.

16. A light source as described in claim 1 chosen from the group consisting of incandescent, fluorescent, halogen, light emitting diodes or combinations thereof.
